(19) United States
(12) Patent Application Publication
(10) Pub. No.: US 2025/0101963 A1
(43) Pub. Date: Mar. 27, 2025

(54) RENEWABLE ENERGY GENERATING SYSTEM & METHOD

(71) Applicant: Beyond Renewables Inc., Toronto, Ontario (CA)

(72) Inventor: Gary Lifshits, Toronto, Ontario (CA)

(73) Assignee: Beyond Renewables Inc., Toronto, Ontario (CA)

(21) Appl. No.: 18/576,961

(22) PCT Filed: Jul. 7, 2022
(86) PCT No.: PCT/CA2022/051069

§ 371 Date: Jan. 5, 2024

Related U.S. Application Data
(60) Provisional application No. 63/358,855, filed on Jul. 6, 2022.
(60) Provisional application No. 63/219,028, filed on Jul. 7, 2021.

(51) Int. Cl. F03G 4/00; F03G 3/00

(52) U.S. Cl. CPC F03G 4/033; F03G 3/094

(57) ABSTRACT

A pod system comprising: a lung module having a first fluid capable of a phase change between a liquid phase and a gaseous phase; and a tether coupled between one end of the pod system and a rotor of an electric generator, whereby when the phase change occurs the pod system's density changes and causes the pod system to move between a first position and a second position within a wellbore, thereby causing the rotor to rotate within a stator of the generator and thereby generate electrical energy.

### FIELD

The present disclosure pertains to energy generators, and more specifically to generators for renewable energy.

### BACKGROUND

Energy generation can present many difficulties. Renewable energy generators may rely on unpredictable sources such as wind or solar energy. Their implementation may present risks to the environment and maintenance. These may be further restricted by their location, and significant energy loss may occur when transporting any energy generator to an end user.

Current renewable technologies rely on external factors which are generally chaotic and
unpredictable in nature. This translates to poor predictability of power supply to an end user and thus requires material investment and usage of energy storage technologies to ensure reliable and consistent power delivery (e.g., wind or solar energy).

Large land area is generally required for commercial scale renewable energies and are materially disruptive to surrounding environments, whether through noise, visuals, habitat pollution, and/or disruption.

Current technologies rely heavily on location specific external factors (e.g., wind, solar coverage, geothermal gradient etc.). This problem is compounded when it comes to power distribution and logistics—the power source is potentially far from an end user. Current technologies are also exposed to natural and created hazards and risks. For example, solar farms are exposed to the natural elements thus requiring rigorous maintenance as well as being at risk for attack on infrastructure.

### SUMMARY

In one aspect, a pod system comprising:
a lung module having a first fluid capable of a phase change between a liquid phase and a gaseous phase; and
a tether coupled between one end of the pod system and a rotor of an electric generator, whereby when the phase change occurs the pod system's density changes and causes the pod system to move between a first position and a second position within a wellbore, thereby causing the rotor to rotate within a stator of the generator and thereby generate electrical energy.

In another aspect, a power generating system comprising:
a pod system comprising a first end and a second end, and at least one lung module between the first end and a second end;
the lung module having a first fluid capable of a phase change between a liquid phase and a gaseous phase;
the pod system moveable between a first position and a second position within an enclosed subterranean environment having a proximal end adjacent a ground surface and a distal end away from the ground surface, wherein the enclosed subterranean environment comprises a second fluid, and wherein the pod system is moveable within the second fluid; and
a tether coupled between the first end of the pod system and an electric generator,
   whereby when the phase change occurs the pod system moves between the first position and the second position causing a rotor within a stator of the generator to rotate and thereby generate electrical energy.

In another aspect, a method of generating electrical energy comprising:
attaching a pod system to a rotor of an electric generator via a tether;
positioning the pod system comprising a lung module, the lung module having a first fluid capable of a phase change between a liquid phase and a gaseous phase, in an enclosed subterranean environment having a second fluid;
causing the first fluid to transform from the gaseous phase to a liquid phase, and introducing the second fluid into the lung module thereby causing the pod system to descend into the enclosed subterranean environment to a second position thereby causing the rotor to rotate and generate electrical energy in a first-half cycle; and
causing the first fluid to transform from the liquid phase to the gaseous phase and expelling the second fluid from the lung module thereby causing the pod system to ascend the enclosed subterranean environment to the first position thereby causing the rotor to rotate and generate electrical energy in a second-half cycle.

In another aspect, a power generating system comprising:
a pod system comprising a first end and a second end, and at least one lung module between the first end and a second end, the at least one lung module having a first fluid capable of a phase change between a liquid phase and a gaseous phase;
an enclosed subterranean environment having a proximal end adjacent a ground surface and a distal end away from the ground surface, wherein the enclosed subterranean environment comprises a second fluid and wherein the pod system is moveable within the second fluid;
an electric generator; and
a tether coupled between the first end of the pod system and the electric generator, whereby when the phase change occurs the pod system moves between a first position and a second position causing a rotor within a stator of the generator to rotate and thereby generate electrical energy.

In another aspect, a power generating system comprising:
a pod system comprising a first end and a second end, and a lung module between the first end and a second end, the at least one lung module having a first fluid capable of a phase change between a liquid phase and a gaseous phase;
an enclosed subterranean environment having a proximal end adjacent a ground surface and a distal end away from the ground surface, wherein the enclosed subterranean environment comprises a second fluid and wherein the pod system is moveable within the second fluid,
the lung module comprising an expandable lung and magnets surrounding the expandable lung, wherein the expandable lung comprises a first chamber with a first fluid and a second chamber with a second fluid, and a piston separating the first chamber and the second chamber, wherein the piston is slideable therein based on a phase change in first fluid housed in the first chamber; and
the enclosed subterranean environment comprising generator stator coils, the coils generating electrical energy as the magnets move over the coils.

In another aspect, a generator, comprising a slider slideably connected to a casing, the slider comprising magnets surrounding a lung. The lung comprises a piston slideable within the casing and moveable from a first position to a second position based on a phase change in refrigerant fluid housed in a chamber defined at a bottom edge by the piston. The generator further comprises a casing, the casing comprising generator stator coils, the coils generating electrical energy as the magnets move over the coils.

In another aspect, a method and system for generating electrical energy or power using buoyancy and gravitational energy as described herein.

In other aspect, the system enables several advantages, examples of which follow. In some implementations, the system can provide electrical energy to end users generated by renewable methods not relying on fossil fuel; convert the liability of a suspended or abandoned oil and gas wells to operating assets; generate power to local in-field demand or connected to the grid; generate energy through a non-emitting renewable energy capture technology independent of geographic conditions and not reliant on external chaotic variables such as sun exposure consistency or wind strength; be deployed as a renewable energy generator physically close to an end user to avoid line losses; minimize the above surface impact on land and environment while providing commercial scale power generation for distribution and use that is comparable to technologies that significantly affect land and environmental contexts.

By not requiring any fossil or non-renewable fuel in its operation, In some implementations, the system can produce electricity through a completely non-emitting process and does not cause any noise, visual, or habitat disruption as the entire system can be operated subsurface with minimal infrastructure above ground.

The system can be deployed in either new or existing wellbores, oil and gas or other, and can be done rather than having to abandon and maintain a liability of suspended or orphaned wells. These same wells can become an asset, utilizing this system to generate power.

As this system provides renewable energy, it can generate electricity via linear motion by using a renewable source for its actuation which is primarily gravity. Acceleration due to gravity is constant, predictable, and exists everywhere and as such makes this system a renewable energy in which its electrical generation is highly predictable, location independent, and has an uptime of 24/7.

In other aspect, this system works linearly with depth, converting potential energy over distance traveled to electrical power. As such, the land footprint is marginal at most, such as with the system using less than a square meter on the surface for its installation and operation. Additionally, due to the nature of its operation with depth relying on potential energy, it is modular and can scale up to higher power generation with additional depth or system design changes such as mass to augment its generation capacity without the need for any additional land area.

Further advantages include the following. The system is dependable, during rain or shine and wind or calm. The system can operate and consistently deliver electrical power. The system can also be location independent, have a minimal surface footprint, have a minimal environmental impact and provide minimal disruptions due to noise or visual effects and have minimal disruptions to a habitat or ecosystem. The system can offer significantly reduced maintenance requirements as it can function as a closed system. The system can also be used to repurpose or recycle existing fossil fuel liabilities and technologies for renewable energy purposes.

In other aspect, the system offers several features such as the following. The system can successfully utilize the effects of gravity to actuate a slider (magnets) through a linear generator along a depth trajectory. Using wellbores for linear travel can allow conversion of potential energy to electrical energy via linear generators. The system can employ passive variable density shifting to vary buoyancy in a liquid medium inducing its ascent and/or descent. The system can shift variable density in a closed system without active work through low temperature variations assisted by shallow geothermal positioning, heat loss resulting from device operation, earth cooling at shallow levels, and active refrigerant cycle cooling. The system can enable a constant pressure, variable temperature phase change chamber through the use of constant force or torque springs, a single piston cylinder, and a closed refrigerant chamber. The system can use wellbores previously used for oil and gas operations or other means as well as using new dedicated wellbores. The system can deploy a linear generator in a wellbore. This can be by deploying stator (coil) sections in casing sections connecting to surface infrastructure for power transmission. The system can include a free body slider within a linear generator not mechanically connected to a spring system for actuation. Gravity and buoyancy can dictate velocity and position of the slider within the stator. The design can be modular and include casing coupling allowing for transmission of power from sequential joints. The slider can have an aerodynamic profile to reduce the drag coefficient and ensure stability in travel while maintaining a constant gap from the stator.

### BRIEF DESCRIPTION OF THE DRAWINGS

FIG. 1 shows a slider installed in a wellbore, according to an embodiment;

FIG. 2 shows positions of a piston within a slider, according to an embodiment;

FIG. 3 shows a modular design of a system including sliders, according to an embodiment;

FIG. 4 shows a chamber housing refrigerant in a slider, according to an embodiment;

FIG. 5 shows a modular design of a system including sliders, according to an embodiment;

FIG. 6 shows a chamber housing refrigerant in a slider, according to an embodiment;

FIG. 7 shows movement of a piston within a slider, according to an embodiment;

FIG. 8 shows a system installed in multiple wellbores, according to an embodiment;

FIG. 9 shows a pod system installed in a wellbore, according to another embodiment;

FIG. 10a shows a support structure and a lung module in a first state;

FIG. 10b shows the support structure with the lung module in a first state;

FIG. 10c shows a pod system with a top connector and a bottom weighted anchor;

FIG. 10d shows a lung comprising a synthetic membrane and rigid support members;

FIG. 11a shows the lung module in a first state;

FIG. 11b shows the lung module in a second state;

FIG. 11c shows the pod system with the lung module in the first state;

FIG. 11d shows the pod system with the lung module in the second state;

FIG. 12 shows the lung module in the second state;

FIG. 13 shows a modular design of a pod system;

FIG. 14a shows chambers of the lung module with well fluid and refrigerant fluid, in a first position of the pod system within the well bore;

FIG. 14b shows a graph of the phase change material (PCM) phase envelope with an operating window, in the first position of the pod system within the wellbore;

FIG. 15a shows chambers of the lung module with well fluid and refrigerant fluid, in a second position of the pod system within the wellbore;

FIG. 15b shows a graph of the phase change material (PCM) phase envelope with an operating window, in the second position of the pod system within the wellbore;

FIG. 15c shows a graph of the phase change material (PCM) density/phase relationship in the second position of the pod system within the wellbore;

FIG. 15d shows the generated power by the pod system, the energy output of the pod system and the net buoyant force of the pod system during ascent; and

FIG. 16 shows an exemplary power generation system for a building.

### DESCRIPTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly to depict certain features of the invention.

In some implementations, a gravitational linear generator actuated through a variable density slider is deployable in a new and/or existing borehole for electrical power generation.

In some implementations, the system is configured to generate renewable energy from the conversion of linear mechanical motion with the use of gravity and changing device density, in a controlled and customizable environment such as a borehole to generate predictable, scalable, and consistent electrical power. In some implementations, this system provides an improved alternative to other renewable technologies such as solar, wind, wave/tidal, geothermal.

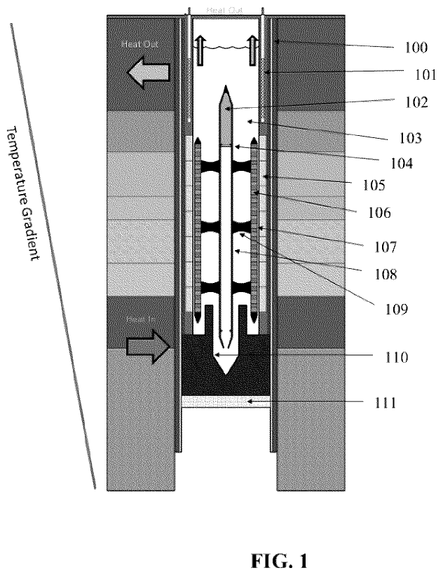

Example embodiments will now be described. FIG. 1 shows a single slider 106, according to some embodiments. Slider 106 can be a pod that can move within a structure. The structure can be filled with fluid 103. Fluid 103 can be a liquid medium that can facilitate or allow for the movement of slider 106. As shown, slider 106 travels up and down freely within a pipe filled with fluid. The pipe can be enclosed within an external cemented wellbore casing 100, for example. This pipe in which the slider travels within has copper coils 105 deployed along its length acting as the stator of a linear generator. Coils 105 can include linear generator coil(s) and circuit(s) and/or can be stationary copper coils, for example. Casing joints 107 can contain linear generator coils 105 within and can separate such circuits from fluid (e.g., well fluid 112) and reduce mechanical or electrical malfunction or risk. Slider 106 consists of magnets on the outside acting as the slider 106 to the stator in a linear generator setup. Slider 106 can be a permanent magnet linear generator slider, for example. There is a minimum gap maintained between the slider magnets and the stator which through the travel of the slider 106 up and down in the pipe passing the coils 105 of the stator, converts the mechanical linear motion of the slider 106 to electrical energy. The pipe which has the copper coils 105 set within sits within an outer casing 100 that is cemented to the earth that surrounds it. This can be installed within existing wellbores used in oil and gas or within newly drilled wellbores.

A slider 106 includes a lung 108. A slider 106 can have one or more lungs 108. Each such lung can be included within separate independent slider units within slider 106. Supports 109 support and/or connect the slider magnets to the lung 108. Lung 108 houses a piston 104 that moves within lung 108. Lung 108 includes chamber 102 that can contain refrigerant fluid. Chamber 102 can be defined by a perimeter of lung 108 at a top end of lung 108 and by piston 104. Piston 104 is actuated and moved by phase changes in refrigerant fluid. Refrigerant fluid is housed in chamber 102 in an amount to allow for piston 104 to cause generation of a pre-determined amount of energy. The amount of fluid within lung 108 can be configured according to design conditions in which it is to be deployed. For example, the liquid volume of this fluid used in lung 108 is calculated such that upon a phase change from liquid to vapour in chamber 102, the expansion ratio of the lung fluid (volume ratio of vapour phase to liquid phase) would result in the full displacement of the piston 104 and thus the full evacuation of the liquid within the chamber on the opposite side of piston 104. The optimal volume of lung fluid in the liquid phase would not necessarily undergo a complete phase change but rather some large percentage of sufficient enough to decrease the average density of the slider 106 such that it becomes buoyant and begins its ascent.

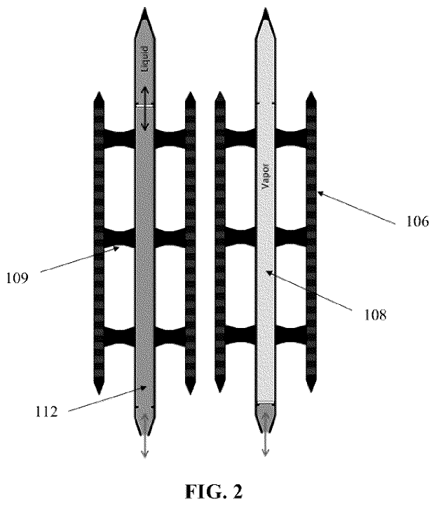

FIG. 2 shows a slider 106 in a first configuration (see left) and in a second configuration (see right), according to some embodiments. Each of the configurations show a different position of the piston 104 within a single slider unit 106 and the fluid properties in each of the positions. Slider 106 includes a lung 108. A lung 108 comprises a piston cylinder track for the displacement of liquid medium through open ports resulting from phase change of refrigerant fluid. In particular, lung 108 includes at least one piston 104 that moves through lung 108 based on change in the phase of refrigerant fluid. Such movement enables the displacement of medium such as fluid through open ports in the lung 108, such as positioned as ports 117. In some implementations, refrigerant fluid generally comprises a high pressure, low temperature range, vapour-liquid phase envelope such as R744 (CO₂ refrigerant) relative to other refrigerants and would be modified such that its reactive properties and characteristics do not impact or hinder the materials nor the operation of the slider components nor would cause material degradation or fatigue over the long term as to reduce the integrity of the mechanical systems. A slider 106 can be comprised of multiple independent slider units each having their own lung 108.

Slider 106 comprises a magnet assembly at an outer perimeter of slider 106, and the magnet assembly is attached to a central column housing a lung 108 via supports 109, such as flexible structural supports. Slider 106 can travel up and down in a fluid filled pipe, such as installed in a wellbore. Lung 108 comprises a chamber that houses a refrigerant like fluid that can change phase from liquid to vapour and vice versa depending on pressure and temperature conditions. Lung 108 can house the refrigerant fluid at one end of lung 108, such as in chamber 102, as shown in the configuration at FIG. 2 (left). The change in phase from liquid to vapour can occur when slider 106 is positioned at a lower or bottom location, such as at a bottom position within a well in which it is installed. This can be due to controlled or existing temperature and/or pressures conditions when slider 106 is at a distance within the ground. The phase change pushes on a piston 104 which is held in place at a specified force, such as via a spring 114 or another device.

At this time, liquid 112 from a well (e.g., liquid wellbore medium) in which the slider 106 is installed is contained within lung 108 and may fill lung 108 from a bottom location up to the perimeter of chamber 102 defined by piston 104. In some implementations, piston 104 or some part of the piston (e.g., coating, intermediate material, etc.) is in contact with the refrigerant fluid and is held in place by the differential pressure outside of the lung along with the spring tension forcing it to its minimum volume position when the refrigerant (e.g., in chamber 102) is entirely liquid phase.

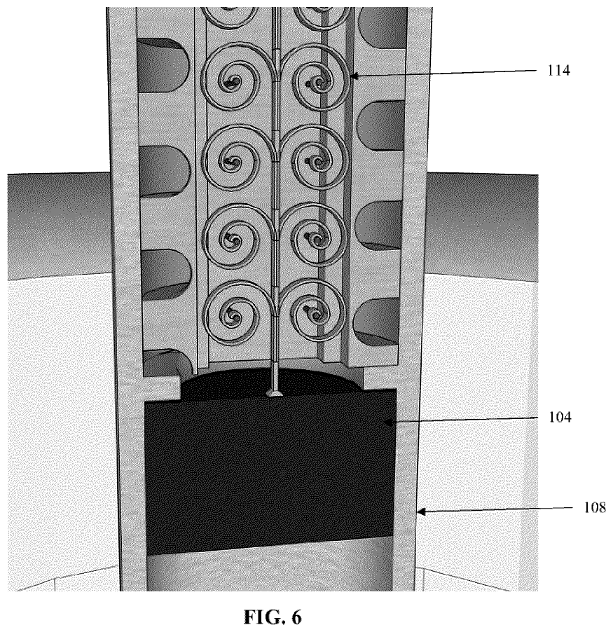

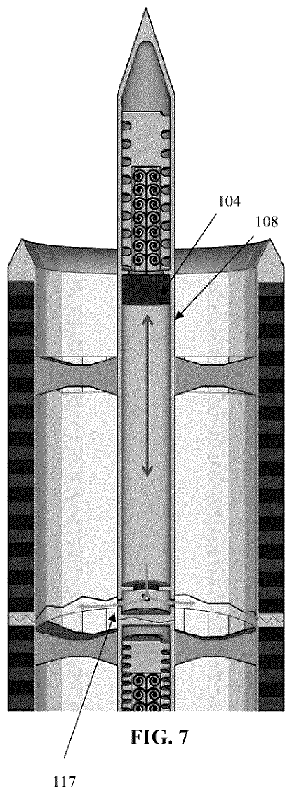

As piston 104 receives force arising from the phase change, piston 104 moves within lung 108 such as in the direction of the force and displaces ambient well liquid out from the inside of lung 108. In the embodiment shown, piston 104 moves downward toward the bottom of lung 108, and displaces the liquid 112 located below piston 104 through port holes located at the bottom of the piston's 104 maximum extension as shown in the figuration at FIG. 2 (right). FIG. 5 shows example lung 108 ports 117 for well liquid 112 entry and exhaust via action of the piston 104. FIG. 7 shows example lung 108 ports 117 that are located between sections having separate lungs 108 in a modular design. As shown, movement of piston 104 exhausts and draws in well liquid 112 into lung 108 of slider 106 via ports 117.

With this displacement of the well liquid 112 from inside of the device, vapour on the other side of the piston 104 occupies that volume causing the average density of the slider 106 to become much lighter. This creates a condition of buoyancy for slider 106 causing it to ascend upwards, such as to move up a well in which it is installed to a surface position.

A change in phase in the refrigerant fluid from vapour to liquid occurs when slider 106 is in a position where conditions (e.g., temperature, pressure) enable the change. For example, when installed in a well within the ground, this can be a shallower position within the well. As the vapour collapses and is converted to liquid, piston 104 displaces upwards drawing in fluid 112 from the well into the chamber of lung 108. Piston 104 is maintained at its position with a spring 114 as shown in FIG. 2 (left). This influx of well liquid 112 into the chamber of lung 108 increases the average density of slider 106. This can allow slider 106 to lose its buoyancy begin to descend in the well.

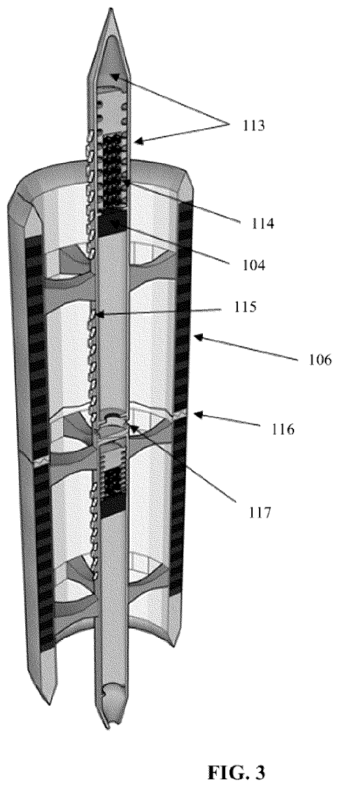

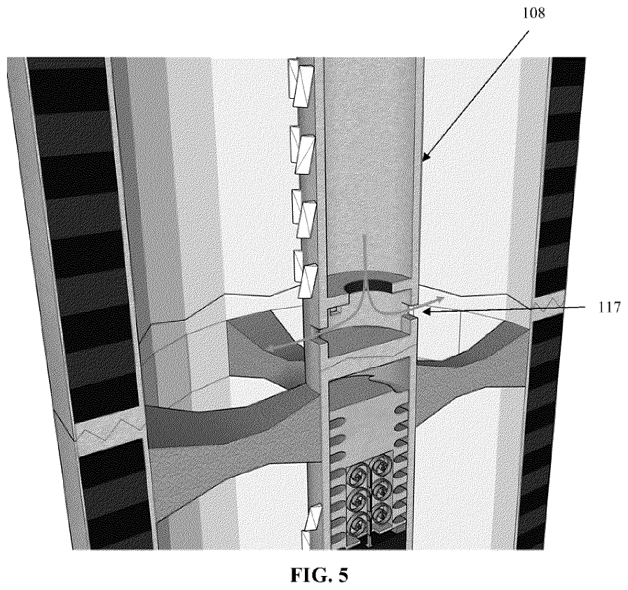

Movement of slider 106 generates electrical energy as its magnets pass over the linear generator stator coils 105 set in stationary casing. Described is an embodiment installed within a well. Lung 108 is actuated by temperature differences in the ambient conditions within and outside the well. This can allow for an engine mechanism with a two-phase working fluid. At the bottom position, the temperature is maintained at a high relative to the surface temperature within the well as a result of natural geothermal gradient, along with heat generated from linear generator 105 via variable resistance breaking (sometimes termed regenerative breaking such as in in electric vehicles). This heat generated by the coils 105 in the deep section of the well maintains a high temperature which heats up the refrigerant fluid in the chamber 102 above the piston 104, causing it to go through a phase change to vapour. Once slider 106 reaches the shallow position, it experiences cooler well temperatures as a result of a cooler external earth temperature due to the geothermal gradient. Thus at the shallow position, the earth can act as a heat sink. In some implementations, as shown in FIG. 1, a thermal conductor material 110 can be positioned at the bottom position near slider 106 at that position. This can facilitate cooling and/or transfer of heat to nearby ground. A bridge plug 111 can be positioned below the thermal conductor material 110 to secure the assembly and/or maintain the components in place and/or isolate a lower part of a wellbore. A cooling effect at the surface position is accelerated further by a refrigeration cycle 101 running through the stator casing circulating cool refrigerant into the casing and back out stealing the heat from the device and maintain a supercooled liquid inside of the well at the surface position. The refrigeration cycle 101 can be located near a surface position of stator 105 such as shown in FIG. 1. Slider 106 can move over such refrigeration cycle 101 as slider 106 moves near the surface. Refrigerant chamber 102 is designed, dimensioned, and shaped in such a way as to allow maximum contact to the external walls of lung 108 which enables faster heat transfer to the well liquid. In some implementations, this is a helical chamber 102 within the slider lung 108 housing the refrigerant. Another view of a helical chamber 113 is shown in FIG. 3. FIG. 3 shows such a chamber housing refrigerant and having a helical chamber design. FIG. 6 shows piston 104 in a lung 108 (and maintained within a piston track that allows for movement) and spring 114 that helps lung 108 maintain its position. Spring 114 can be coil springs as shown.

To ensure maximum power delivery, the slider 106 is held in the surface position until the chamber is filled completely with well liquid to allow for maximum descent velocity and likewise the slider 106 is held in position at the bottom until the slider 106 reaches maximum buoyancy for maximum ascent velocity. The slider 106 will be held at surface or bottom positions by either mechanical devices (e.g., locking pins and pressure switches) or solenoid actuated locks/pins holding the slider 106 in these positions until a minimum force is registered causing the release and free motion to begin. To ensure maximum power delivery, additional aerodynamic components such as fins 115 as shown in FIG. 3 can be included to induce rotation or spin of the slider 106 during its travel up and down so as to keep the vertical alignment of the slider 106 as stable as possible.

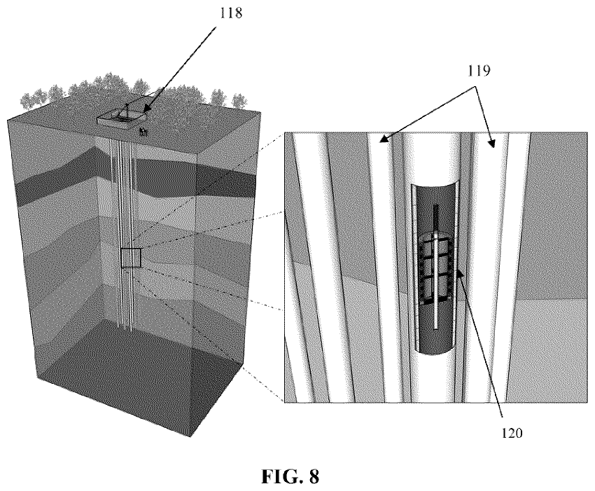

FIG. 3 is a cross-sectional view of two slider units, according to some embodiments. In some implementations, the slider 106 is modular in nature and independent sections of it can be pieced together as can been seen in FIG. 3. Each section can have its own lung 108 (including a piston 104 and a chamber 102 housing refrigerant) and can be joined (e.g., screwed) together, such as similarly to how casing or tubing joints are pieced together in an oil and gas well installation. The joining can be using connectors 116 of slider 106 segments at an outer casing of slider 106. Therefore, there is no limit to the total length of the slider and no limit to the depth of the well. More than one section can be joined. Therefore, each well is capable of scaling up its power generation capacity and the detailed design conditions of each component is varied to the depth and diameter conditions of each wellbore. In some implementations, the system is also modular and can couple one or more of these assembled devices (e.g., containing one or more sections) in several wells in a tight area and can connect the power from each together. The power is collected from each device or system using electrical connectors similar to those used to collected from wind turbines or solar panels to a single station. FIG. 8 shows an example system deployed in several wells 119 drilled into the earth grouped together on the surface into a single power collector 118. On the right is an enlarged version showing a cross-section of the wellbore depicting slider 120 set within the stator.

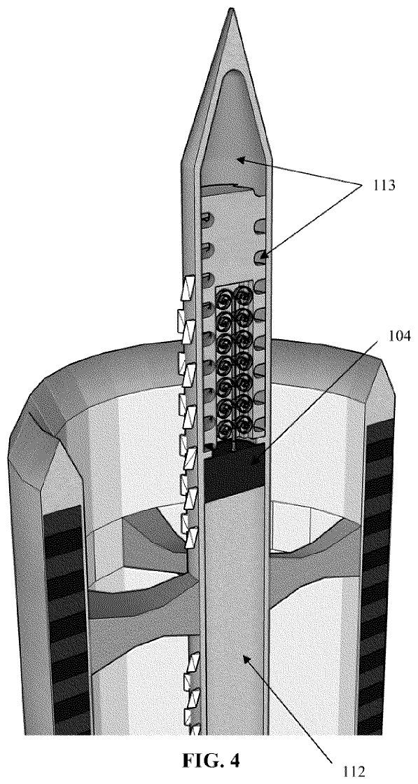

FIG. 4 shows a slider 106 having refrigerant chamber 113, according to some embodiments. Chamber 113 is a helical chamber in the embodiment shown. The helical design helps ensure maximum contact of refrigerant to the external walls of slider 106 and this can help accelerate heat exchange with the well liquid. This can accelerate phase change of the refrigerant, movement of the piston 104, change in buoyancy of slider 106, and corresponding movement of slider 106. Such movement can generate electrical energy as described.

In some implementations, stator 105 and slider 106 are installed into wellbores with rig equipment such as those used for an oil and gas well. The stator 105 is installed to sit on top of a bridge plug 111 used to isolate sections within a wellbore when suspending or abandoning a well to add a flow barrier inside the pipe. The thermal conductivity of the wellbore is designed and configured to allow fast transmission of heat energy to the earth surrounding the wellbore.

The system including one or more sliders 106 also works in shallow depths, much shallower than used for geothermal energy, as it does not require high earth temperatures to actuate the lung 108 and can be deployed in various wellbore diameters. Average geothermal gradient is adequate for the operation of the system and so is applicable anywhere in the world. The particular location geothermal gradients are used to tune the lung 108 parameters to adjust the operating temperature ranges to fit location characteristics to optimize power output. The system can be connected to a system controller on the surface to monitor temperature, pressure, velocity, and power generation conditions to optimize operating parameters and energy output. The system can work continuously without stopping and does not require intervention for its continued operation. It can therefore be completely predictable regarding its power output and can operate 24/7 irrespective of external conditions or climates.

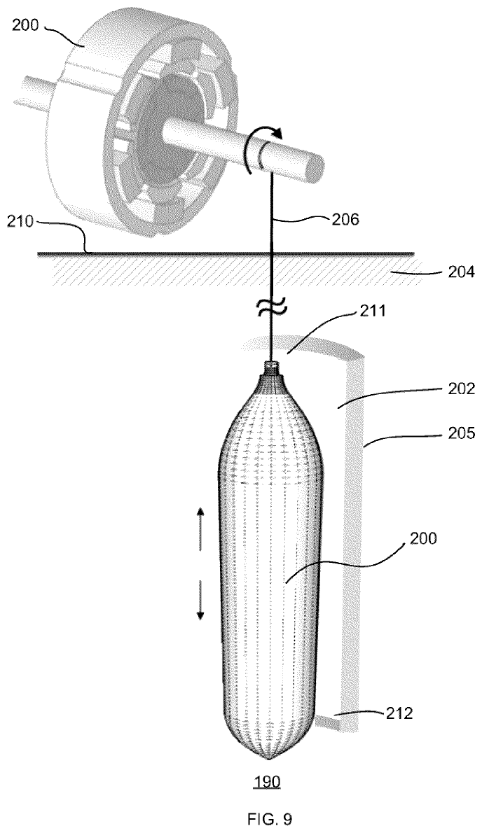

In another exemplary implementation, looking at FIG. 9, there is shown a power generating system 190 comprising a variable density pod system 200 that is deployable in a structure, such as a wellbore 202 drilled into the earth 204, with well casing 205. The variable density pod system 200 combines uses gravity and its variable density to move between a first position and a second position and drive a rotor associated with a generator. As described previously, the structure 202 may be filled with a fluid, such as a liquid medium that can facilitate the movement of the pod system 200 within the wellbore 202. The pod system 200 is attached via cable 206 to an above ground power generator 208 on a surface 210. As the pod system 200 descends into the wellbore 202 away from a well top 211 near the surface 210 towards a well bottom 212, the cable 206 drives a rotor associated with the above ground conventional surface rotary generator 208 and generates electricity. Once the pod system 200 reaches the well bottom 212, the pod system 200 gains buoyancy begins to ascend the wellbore 202 towards the well top 211 near the surface 210, as will be described in more detail below. After the pod system 200 reaches the well top 211, it begins the descent again, and the cycle repeats, all the while generating electrical power.

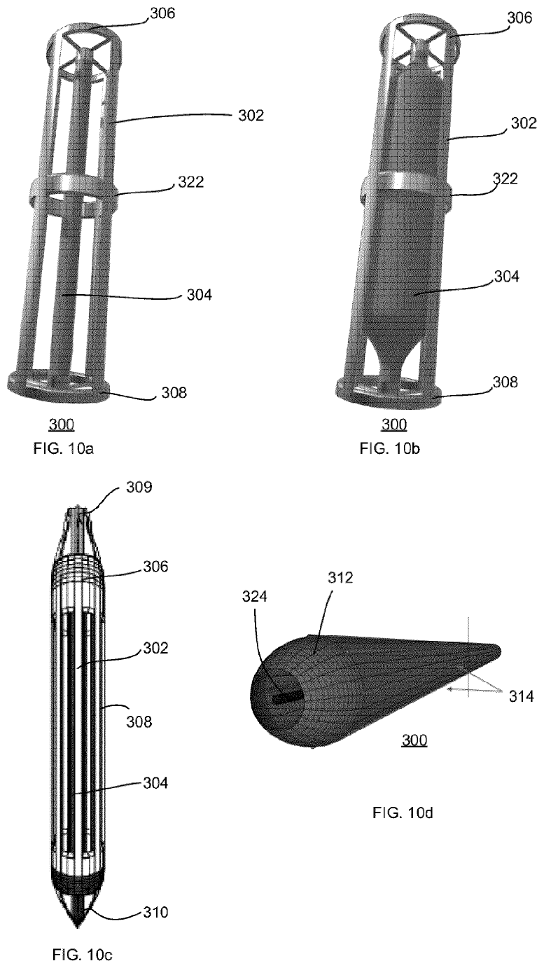

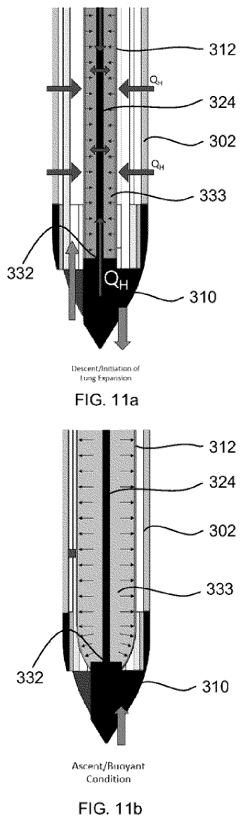

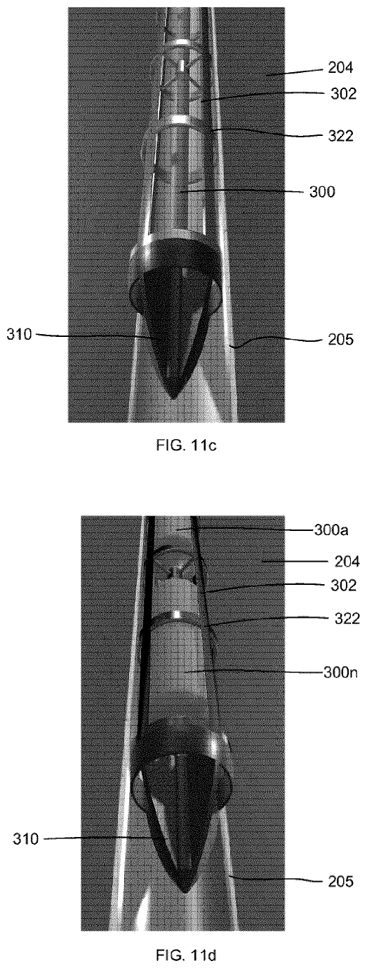

The pod system 200 comprises a lung module 300 which further includes a support structure 302 housing a lung 304. As can be seen in FIGS. 10a, 10b, 10c lung 304 extends between a top end 306 of the support structure 302 and a bottom end 304 of the support structure 302. In more detail, the top end 306 of the support structure 302 includes a top connector 309, and the top end 306 may include resistance heating and sensors to optimize the performance of the lung module 300. The bottom end 304 may include a weighted conductive assembly 310 with conductive material to increase heat transfer to the lung fluid, as will be described in detail below. In addition, the bottom end 304 may also include a variable weight anchor to increase the weight of the pod system 200. In one example, lung 304 comprises a synthetic membrane 312 with rigid support members 314, or skeleton support structure, as shown in FIG. 10d. The support structure 302 comprises a top end 318 and a bottom end 320, and midsection 322, and a central column 324 extending between the top end 318 and the bottom end 320. The lung 304 is therefore supported by the central column 324, and the support structure 302, as shown in FIGS. 11a and 11b. The central column 324 and the skeleton support structure 314 promote uniform rigidity along the length of lung 304, and also provides constant volume during descent and ascent of the pod system 200.

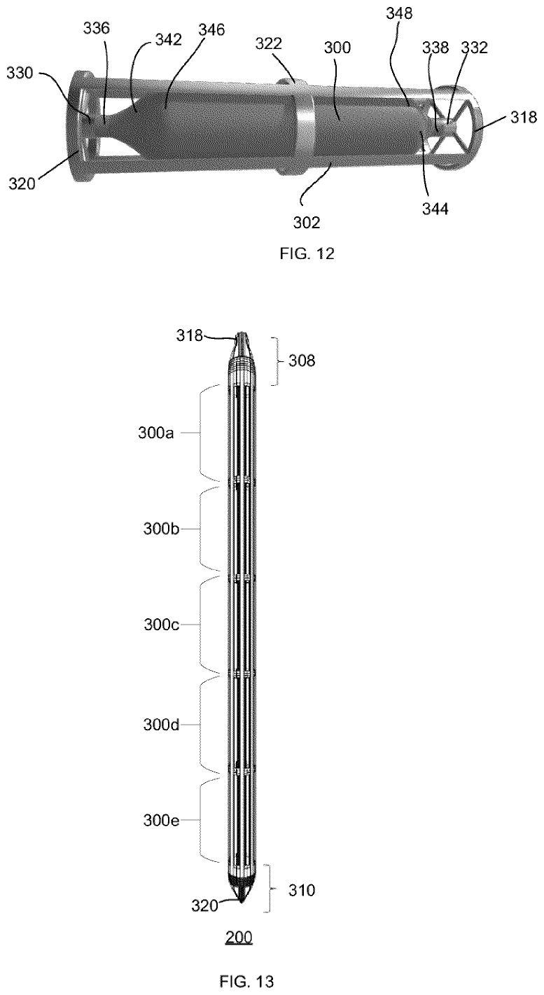

Looking at FIG. 12, lung 304 is secured between the top end 318 and the bottom end 320 via top projecting plug 330 and bottom projecting plug 332 such that a fluid may be contained within the lung 304. Top projecting plug 330 and bottom projecting plug 332 face each other and receive end portions 336, 338, respectively. When the lung 304 is fully inflated, the lung comprises a cylindrical portion 340 between frustoconical portions 342, 344. As such, the frustoconical portion 342 is formed between the end portion 336 at top projecting plug 330 and one end 346 of the cylindrical portion 340. Correspondingly, the frustoconical portion 344 is formed between the end portion 338 at bottom projecting plug 332 and one end 348 of the cylindrical portion 340. The frustoconical portions 342, 344 are so shaped to facilitate the well liquid 406 to pass with minimal resistance and put minimal pressure/stress on the lung 304 due to restricted flow and perpendicular attack angle.

As shown in FIG. 13, the lung module 300 may be modular. In one example, multiple lung modules 300a, 300b, 300c, 300d and 300e are coupled to each other adding weight and buoyancy capacity to the overall pod system 200. The lung modules 300a-n are bookended by the weighted pointed lead section 310 at bottom end 320 and the top connector 308 at the top end 318 having a cable connection to the power generator 208 on the surface 210. The lung modules 300a-n are controllable such that similar, or dissimilar, phase changes in the fluid chambers of lung modules 300a-n occur at locations within the wellbore 202 between the first and second positions, during ascent and descent. For example, the density of the modular pod system 200 may be varied by having different lung modules 300a-n in different liquid/gas phases.

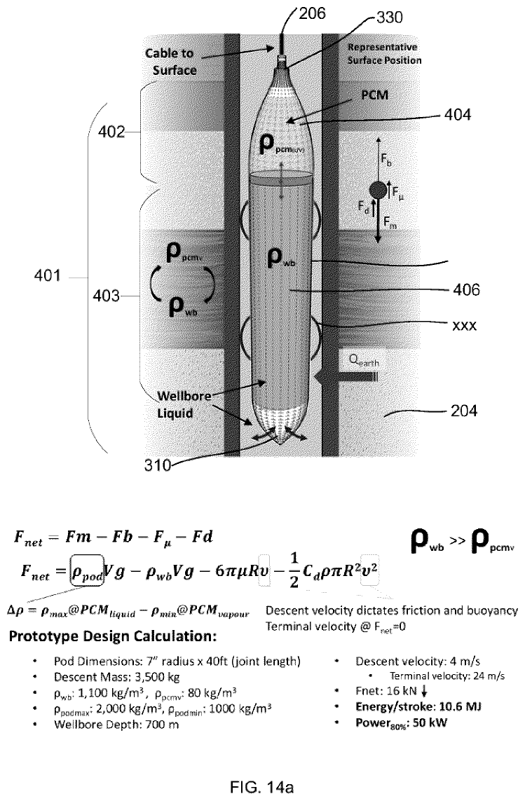

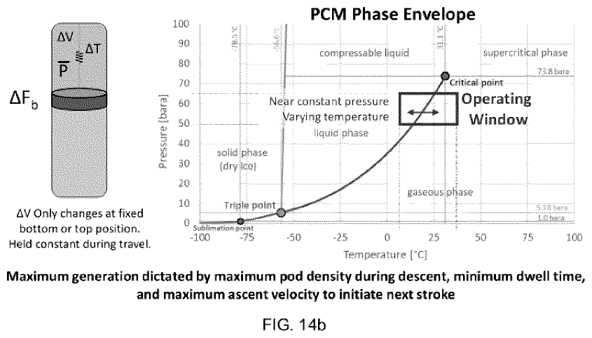

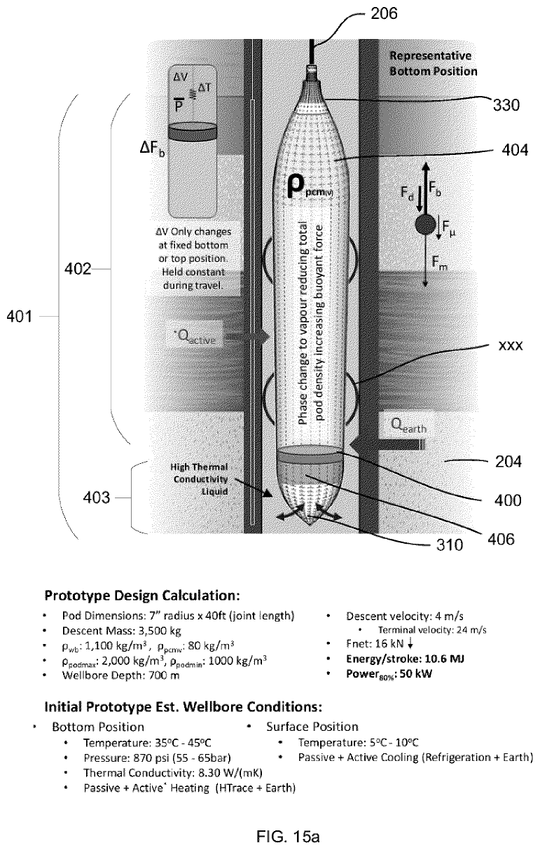

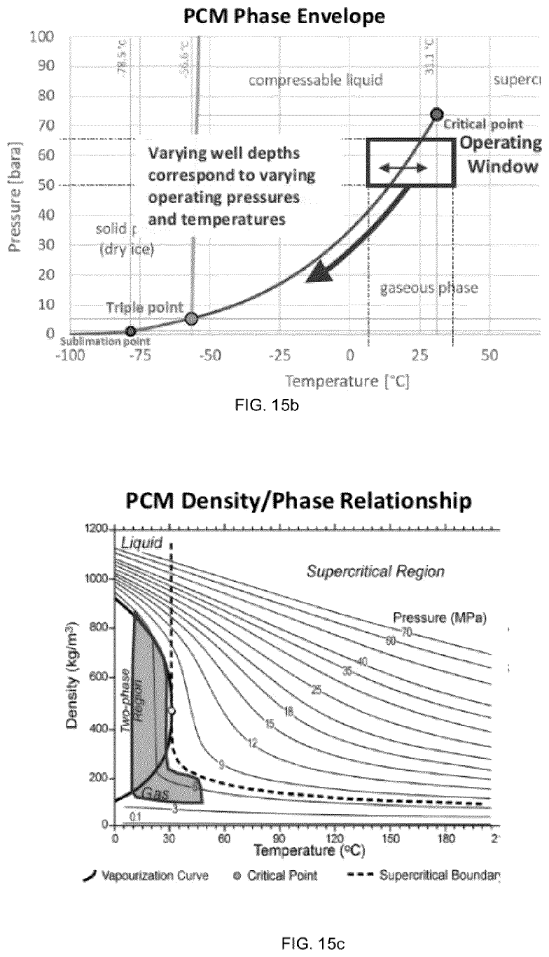

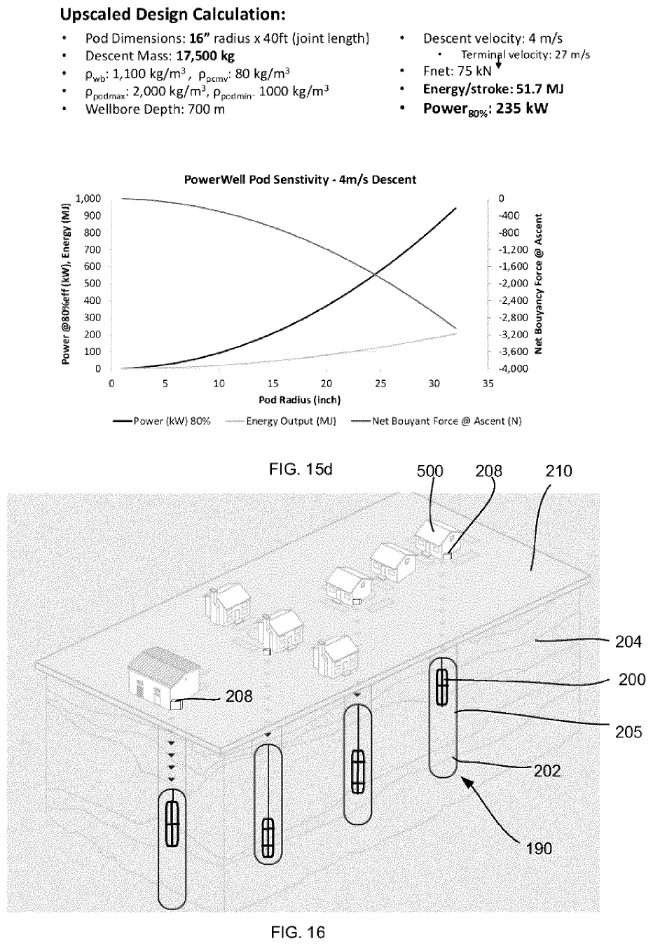

Now looking at FIGS. 14a, 15a, lung 304 houses a piston 400 that moves within a chamber 401 within lung 304. Chamber 401 comprises top chamber 402 and bottom chamber 403, which are separated from each other by the piston 400. The central column 324 comprises one or more ports in fluid communication with the bottom chamber 403 and the wellbore 202, such that well fluid 406 is introduced into the bottom chamber 403 or expelled from the bottom chamber 403 to facilitate movement of the pod system 200 between the first position and the second position. Top chamber 402 may contain refrigerant fluid 404 in a sufficient amount to allow for the piston 400 to cause generation of a pre-determined amount of energy. The top chamber 402 is defined between the top projecting plug 330 and the piston 400. The bottom chamber is defined between the bottom projecting plug 332 and the piston 400, and may contain well fluid 406. The piston 400 is actuated and moved by phase changes in refrigerant fluid 404. The amount of fluid within lung 400 can be configured according to design conditions in which it is to be deployed. For example, the liquid volume of this fluid used in lung 304 is calculated such that upon a phase change from liquid to vapour in chamber 402, the expansion ratio of the lung fluid 404 (volume ratio of vapour phase to liquid phase) would result in the full displacement of the piston 400 and thus the full evacuation of the liquid within the chamber 402 on the opposite side of the piston 400. The optimal volume of refrigerant fluid 404 in the liquid phase would not necessarily undergo a complete phase change but rather some large percentage of it sufficient to decrease the average density of the pod system 200 such that it becomes buoyant and begins its ascent.

The refrigerant fluid 404 in chamber 402 can change phase from liquid to vapour and vice versa depending on pressure and temperature conditions. The change in phase from liquid to vapour can occur when the pod system 200 is positioned at a lower or bottom location, such as at a bottom position within a wellbore 202 in which it is installed. This can be due to controlled or existing temperature and/or pressures conditions when pod system 200 is at a distance within the ground 204. The phase change pushes on the piston 400 which is held in place at a specified force, such as via a spring or other device.

As shown in FIG. 14a, starting with the pod system 200 at the bottom of the wellbore 202, the volume of chamber 401 with well fluid 406 is greater than the volume of the chamber 402 with refrigerant fluid 404. As such the volume of chamber 403 is greater than the volume of the chamber 402. Generally, the well fluid 406 is filled into the chamber 402 from one or more ports within the bottom projecting plug 332 into the central column 324 for eventual expulsion into the chamber 403. In some implementations, the piston 400 or some part of the piston 400 (e.g., coating, intermediate material, etc.) is in contact with the refrigerant fluid 404 and is held in place by the differential pressure outside of the lung 304 along with the spring tension forcing it to its minimum volume position when the refrigerant fluid 404 in chamber 402 is entirely liquid phase. FIG. 14b shows a graph of the phase change material (PCM) phase envelope with an operating window. The energy generated by the pod system 200 is dictated, at least, by the maximum pod density during descent, minimum dwell time, and maximum ascent velocity. The speed of the pod system 200 may be controlled by a braking system.

The following are exemplary specifications for the pod system 200 and wellbore 202:
Pod Dimensions: 7″ radius×40 ft (joint length)
Descent Mass: 3,500 kg
ρ_{wb}: 1,100 kg/m3, ρ_{pcmv}: 80 kg/m³
ρ_{podma}x: 2,000 kg/m3, ρ_{podmin}: 1000 kg/m³
Wellbore depth: 700 m
Descent velocity: 4 m/s
Terminal velocity: 24 m/s
Fₙₑₜ: 16 kN
Energy/stroke: 10.6 MJ
Power₈₀%: 50 kW

As the piston 400 receives a force arising from the phase change, the piston 400 moves within lung 304 such as in the direction of the force and displaces ambient well liquid 406 out from the inside of lung 304. In one example, the piston 400 moves downward toward the bottom projecting plug 332, and displaces the well liquid 406 located below the piston 400 through port holes located at the bottom of the piston's 400 maximum extension as shown in the configuration at FIG. 2. Similar to the embodiment shown in FIG. 5, pod system 200 comprises exemplary lung 304 ports 117 for well liquid 406 entry and exhaust via action of the piston 400. Similar to the embodiment shown in FIG. 7, pod system 200 comprises exemplary lung 304 ports 117 that are located between sections having separate lungs 304 in a modular design. Similarly, movement of the piston 400 exhausts and draws in well liquid 406 into lung 108 of pod system 200 via ports 117.

With this displacement of the well liquid 406 from chamber 403, vapour generated due to the phase change in chamber 402 on the other side of the piston 400 occupies that volume causing the average density of the pod system 200 to become much lighter. This creates a condition of buoyancy for the pod system 200 causing it to ascend towards the surface 210, such as to move up a wellbore 202, as shown in FIG. 15a. At the well bottom 212, the higher ambient temperature condition heats up the lung fluid 404 causing a phase change to vapor from liquid, and expands the lung membrane 312. The pod system 200 stays in position until a maximum buoyancy condition is reached, at which instance a catch and lock mechanism set in the enclosed subterranean environment bottom releases upon set force applied up due to a maximum buoyancy of the pod system 200. The increasing pressure and increasing force internally against the membrane beyond the force of tension of the membrane and the hydrostatic head of the well liquid 404 column causes the pod system 200 to ascend. Accordingly, the catch and lock mechanism maintains the pod system at desired depths within the wellbore 202 and releases when predefined conditions are met. The catch and lock mechanism may comprise mechanically actuated lock pins, electrically actuated lock pins, gears, sensors, switches, and motors.

Next, a change in phase in the refrigerant fluid 404 from vapour to liquid occurs when pod system 200 is in a position where conditions (e.g., temperature, pressure) enable the change. For example, when installed in a wellbore 202 within the earth 204, this can be a closer to the surface 210. As the vapour collapses and is converted to liquid, the piston 400 displaces upwards drawing in well fluid 406 from the wellbore 202 into the bottom chamber 403. Piston 104 is maintained at its position with a spring 114 as shown in FIG. 2 (left). This influx of well liquid 406 into the bottom chamber 403 of lung 304 increases the average density of the pod system 200. As such, the pod system 200 loses its buoyancy begin to descend towards the bottom of the wellbore 202, as shown in FIG. 15a. Heat is shed from the lung module 300 due to the lower ambient temperature and the refrigerant fluid 404 changes from vapor to liquid, and together with the dropping pressure facilitates deflation of the membrane 312, thereby increasing the average density of the pod system 200 until a maximum sinking force is achieved to start a descent cycle. FIG. 15b shows a graph of the phase change material (PCM) phase envelope with an operating window. FIG. 15c shows a graph of the phase change material (PCM) density/phase relationship, in the second position of the pod system within the wellbore 202.

FIG. 15d shows the generated power by the pod system, the energy output of the pod system and the net buoyant force of the pod system during ascent, including exemplary specifications for the pod system 200 and wellbore 202. In one example, scaling power delivery at shallow operating depths is optimally achieved by increasing wellbore 202 and pod system 200 diameter—e.g. 1 MW @ 32″ radius. To further scale the power output, the pod system 200 may include larger diameters, and may be operated in deeper wells for longer travel distances, and the PCM properties/phase envelope may be modified for greater optimization.

FIG. 16 shows an exemplary power generation system 190 for generating power for a building 500.

In another implementation, alternative means for varying the average system density of the pod system 200 to vary the pod system 200's buoyancy set in a dense liquid column, such as dissociation (e.g., gas dissolved in liquid), or dissolution (e.g., methyl hydrates, acetylene dissolved in acetone).

In another implementation, the lung module 304 comprises one or more enclosed chambers, and the one or more enclosed chambers may include one or more top chambers and/or one or more bottom chambers.

In another implementation, the pod system 200 comprises electronic circuitry which receives inputs from sensors to control and optimize lung performance. This onboard generation may also be used to supply resistance heating to accelerate the temperature exchange downhole without needing insulated cabling to the surface. The sensors may include strain, temperature, speed, brakes, power, and pressure sensors, including accelerometers.

In another implementation, the system 190 comprises a monitoring system that receives inputs from the various sensors, such as strain, temperature, speed, power, brakes, and pressure sensors, accelerometers, during ascent, descent of the pod system 200, or when the pod system 200 is stationary. Accordingly, the monitoring system is configured to issue alerts related to abnormal conditions, or notifications related to the operating conditions of the pod system 200 or system 190.

In another implementation, the pod system 200 comprises turbines for generating low level power for the electronic circuitry onboard the pod system 200.

In another implementation, the pod system 200 comprises improved fluid characteristics used inside the lung module 304 to enable lower operating pressure and lower operating temperature for the liquid phase, and to enable higher pressure/temperature operation for gas phase allowing for deeper bottom hole depths allowing for longer travel of the pod system 200.

In another implementation, the pod system 200 comprises an active cooling via cooling refrigeration cycle of the shallow portion of the wellbore 202 where passive cooling is to take place in locked surface pod position.

In another implementation, lung modules 300a-n of the pod system 200 may be laterally connected in a modular way. Such a configuration may minimize challenges of manufacturing large diameter lungs 304 for very large diameter wellbores 202 (honeycomb configuration).

In another implementation, a plurality of pod systems 200 are deployed together, or simultaneously, in one well or multiple wells, to drive a single centralized generator on the surface.

In another implementation, the refrigerant fluid 404 comprises a plurality of different formulations.

In another implementation, the wellbore fluid 406 comprises a plurality of different formulations.

In another implementation, the locking mechanism of the lung membrane 312 and the skeletal support structure 314 within the membrane 312 to keep the volume fixed on travel (ascent and descent) can be designed in infinitely different ways.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

1-20. (canceled)

21. A power generating system comprising:
a pod system comprising a first end and a second end, and at least one lung module between the first end and the second end;
the at least one lung module having a first fluid capable of a phase change between a liquid phase and a gaseous phase;
the pod system moveable between a first position and a second position within an enclosed subterranean environment having a proximal end adjacent a ground surface and a distal end away from the ground surface, wherein the enclosed subterranean environment comprises a second fluid, and wherein the pod system is moveable within the second fluid;
a tether coupled between the first end of the pod system and an electric generator, whereby when the phase change occurs the pod system moves between the first position and the second position causing a rotor within a stator of the generator to rotate and thereby generate electrical energy; and
wherein a plurality of pod systems is operable in different enclosed subterranean environments and are coupled to drive a single centralized generator.

22-23. (canceled)

24. The power generating system of claim 21, wherein the at least one lung module comprises at least one enclosed chamber comprising at least one first chamber and at least one second chamber, wherein the at least one first chamber and the at least one second chamber are separated by a piston.

25. The power generating system of claim 24, wherein the at least one first chamber comprises the first fluid, and the at least one second chamber comprises the second fluid of the enclosed subterranean environment.

26. The power generating system of claim 24, wherein the least one first chamber comprises the first fluid in a sufficient amount to cause the piston to move in response to phase changes in the first fluid, and regulate an amount of the first fluid and an amount of the second fluid within the at least one lung module, thereby varying the pod system's density.

27. The power generating system of claim 26, wherein the at least one lung module comprises least one port in fluid communication with the at least one second chamber and the enclosed subterranean environment, such the second fluid is introduced into the at least one second chamber or expelled from the at least one second chamber to facilitate movement of the pod system between the first position and the second position.

28. (canceled)

29. The power generating system of claim 2, wherein the at least one lung module is controllable such that each at least one first chamber and each at least one second chamber of the at least one lung module has similar liquid phase changes and gaseous phase changes at any given instance, wherein the pod system has a variable density depending on an individual density of each of the at least one lung module at a given instance.

30. The power generating system of claim 2, wherein the at least one lung module is controllable such that each at least one first chamber and each at least one second chamber of the at least one lung module has different liquid phase changes and gaseous phase changes, wherein the pod system has a variable density depending on the individual density of each of the at least one lung module at a given instance.

31-32. (canceled)

33. A method of generating electrical energy comprising:
attaching a pod system to a rotor of an electric generator via a tether;
positioning the pod system comprising a lung module, the lung module having a first fluid capable of a phase change between a liquid phase and a gaseous phase, in an enclosed subterranean environment having a second fluid, and wherein the lung module comprises an expandable membrane;
causing the first fluid to transform from the gaseous phase to a liquid phase, and
introducing the second fluid into the lung module thereby causing the pod system to descend into the enclosed subterranean environment to a second position thereby causing the rotor to rotate and generate electrical energy in a first-half cycle; and
causing the first fluid to transform from the liquid phase to the gaseous phase and expelling the second fluid from the lung module thereby causing the pod system to ascend the enclosed subterranean environment to a first position thereby causing the rotor to rotate and generate electrical energy in a second-half cycle.

34. The method of claim 33, wherein the lung module comprises at least one enclosed chamber comprising at least one first chamber and at least one second chamber, wherein the at least one first chamber and the at least one second chamber are separated by a piston.

35. The method of claim 33, wherein the pod system comprises a weighted conductive assembly configured to regulate heat transfer to the first fluid to control the phase change of the first fluid.

36. The method of claim 33, wherein the pod system comprises a variable weight anchor to control the pod system's speed within the second fluid of the enclosed subterranean environment.

37. (canceled)

38. The method of claim 36, wherein heat is shed from the lung module due to a lower ambient temperature near a top end of the enclosed subterranean environment and the first fluid changes to liquid, and deflates the expandable membrane, thereby increasing an average density of the pod system until a maximum sinking force is achieved to start a descent cycle.

39. The method of claim 38, wherein at the second position, a higher ambient temperature near a bottom end of the enclosed subterranean environment heats up the first fluid causing a phase change to vapor, expanding the expandable membrane to initiate an ascent cycle.

40. The method of claim 39, wherein the pod system stays at the second position until a maximum buoyancy condition is reached.

41. The method of claim 40, wherein a catch and lock mechanism maintains the pod system at desired depths within the enclosed subterranean environment and releases when predefined conditions are met.

42. The method of claim 41, wherein the catch and lock mechanism comprises at least one of mechanically actuated lock pins, electrically actuated lock pins, gears, sensors, switches and motors.

43-50. (canceled)

51. A power generating system comprising:
a pod system comprising a first end and a second end, and at least one lung module between the first end and the second end, the at least one lung module having a first fluid capable of a phase change between a liquid phase and a gaseous phase;
an enclosed subterranean environment having a proximal end adjacent a ground surface and a distal end away from the ground surface, wherein the enclosed subterranean environment comprises a second fluid and wherein the pod system is moveable within the second fluid,
the lung module comprising an expandable lung and magnets surrounding the expandable lung, wherein the expandable lung comprises a first chamber with the first fluid and a second chamber with the second fluid, and a piston separating the first chamber and the second chamber, wherein the piston is slideable therein based on a phase change in first fluid housed in the first chamber; and
the enclosed subterranean environment comprising generator stator coils, the coils generating electrical energy as the magnets move over the coils.

52. The power generating system of claim 51, wherein the first chamber comprises the first fluid in a sufficient amount to cause the piston to move in response to phase changes in the first fluid, and regulate an amount of the first fluid and an amount of the second fluid within the expandable lung, thereby varying the pod system's density.

53. The power generating system of claim 52, wherein the lung module comprises least one port in fluid communication with the second chamber and the enclosed subterranean environment, such the second fluid is introduced into the second chamber or expelled from the second chamber to facilitate movement of the pod system between a first position and a second position within the enclosed subterranean environment.

54. The power generating system of claim 53, wherein the pod system comprises a weighted conductive assembly configured to regulate heat transfer to the first fluid to control the phase change of the first fluid.

55. The power generating system of claim 53, wherein the pod system comprises a variable weight anchor to control the pod system's speed within the second fluid of the enclosed subterranean environment.

56. The power generating system of claim 55, wherein heat is shed from the lung module due to a lower ambient temperature near the proximal end of the enclosed subterranean environment and the first fluid changes to liquid, and deflates an expandable membrane, thereby increasing an average density of the pod system until a maximum sinking force is achieved to start a descent cycle.

57. The power generating system of claim 56, wherein at the second position, a higher ambient temperature near the distal end of the enclosed subterranean environment heats up the first fluid causing the phase change to vapor, expanding the expandable lung to initiate an ascent cycle.

58. The power generating system of claim 57, wherein the pod system stays at the second position until a maximum buoyancy condition is reached.

59. The power generating system of claim 57, wherein a catch and lock mechanism maintains the pod system at desired depths within the enclosed subterranean environment and releases when predefined conditions are met.

60. The power generating system of claim 59, wherein the catch and lock mechanism comprises at least one of mechanically actuated lock pins, electrically actuated lock pins, gears, sensors, switches and motors.
